(19) United States
(12) Patent Application Publication
(10) Pub. No.: US 2026/0261568 A1
(43) Pub. Date: Sep. 3, 2026

(54) ABNORMALITY DETECTION DEVICE, ABNORMALITY DETECTION METHOD, AND ABNORMALITY DETECTION PROGRAM

(71) Applicant: NTT, Inc., Tokyo (JP)

(72) Inventors: Naoto FUJIKI, Musashino-shi, Tokyo (JP); Takaaki KOYAMA, Musashino-shi, Tokyo (JP); Yukio NAGAFUCHI, Musashino-shi, Tokyo (JP); Nobuhiro CHIBA, Musashino-shi, Tokyo (JP)

(73) Assignee: NTT, Inc., Tokyo (JP)

(21) Appl. No.: 19/158,083

(22) PCT Filed: Feb. 27, 2023
(86) PCT No.: PCT/JP2023/007104

§ 371 Date: Aug. 20, 2025

(51) Int. Cl. H04L 9/40

(52) U.S. Cl. CPC H04L 63/1416

(57) ABSTRACT

An anomaly detection device includes processing circuitry configured to determine whether anomaly communication has occurred by inputting a feature of a packet during a given period transmitted and received on a network to a learning model trained in advance using a plurality of pieces of learning data; calculate a value for each monitoring item of the packet during the given period when the anomaly communication has occurred; and visibly display a difference between a value for each monitoring item of the plurality of pieces of learning data and a value for each feature item of the packet during the given period.

### TECHNICAL FIELD

The present invention relates to an anomaly detection device, an anomaly detection method, and an anomaly detection program.

### BACKGROUND ART

Techniques for detecting network anomalies include, for example, signature type anomaly detection and anomaly type anomaly detection. In the signature type anomaly detection, illegal patterns are registered in advance in a database, and communication matching the registered illegal pattern is detected. For example, in the technique of NPL 1, when known anomaly communication is detected by the signature type anomaly detection, information regarding the detected anomaly communication is grouped by pattern matching to be visualized.

In the signature type anomaly detection, it is difficult to defend unknown anomaly communication although known anomaly communication can be detected and attacks can be blocked.

On the other hand, in the anomaly type anomaly detection, normal patterns are registered in advance in a database, and communications unsuitable for the registered normal patterns are all detected. In the anomaly type anomaly detection, unknown anomaly communication which cannot be detected by the signature type anomaly detection can be detected. For example, as a technique related to the anomaly type anomaly detection, there is a technique for detecting an anomaly or an inappropriate behavior on a network based on steady evaluation of flow statistical information.

### CITATION LIST

### Non Patent Literature

[NPL 1] “Nozomi Networks Gurdian” [online], [retrieved on 6 Feb. 2023], Internet <URL:https://www.nozominetworks.com/products/guardian/>

### SUMMARY OF INVENTION

### Technical Problem

For example, although unknown anomaly communication can be detected in anomaly type anomaly detection, there is a problem that it is not possible to ascertain what type of anomaly communication the detected anomaly communication is, and how it differs from normal communication.

The present invention has been made in view of the foregoing circumstances, and an object of the present invention is to provide an anomaly detection device, an anomaly detection method, and an anomaly detection program capable of providing information with which types of detected anomaly communication and differences from normal communication can be ascertained.

### Solution to Problem

In order to solve the above problem and to achieve the object, an anomaly detection device includes: a determination unit configured to determine whether anomaly communication has occurred by inputting a feature of a packet during a given period transmitted and received on a network to a learning model trained in advance using a plurality of pieces of learning data; a calculation unit configured to calculate a value for each monitoring item of the packet during the given period when the anomaly communication has occurred; and a display processing unit configured to visibly display a difference between a value for each monitoring item of the plurality of pieces of learning data and a value for each feature item of the packet during the given period.

### Advantageous Effects of Invention

According to the present invention, it is possible to provide information with which types of detected anomaly communication and differences from normal communication can be ascertained.

### BRIEF DESCRIPTION OF DRAWINGS

FIG. 1 is a diagram illustrating a configuration example of a network including an anomaly detection device according to an embodiment.

FIG. 2 is a functional block diagram illustrating a configuration of the anomaly detection device according to the embodiment.

FIG. 3 is a diagram illustrating an example of a data structure of a packet buffer.

FIG. 4 is a diagram illustrating an example of a data structure of learning data collection information.

FIG. 5 is a diagram illustrating an example of a data structure of alert collection information.

FIG. 6 is a diagram illustrating an example of a data structure of a correspondence table.

FIG. 7 is a diagram illustrating an example of screen information generated by a display control unit.

FIG. 8 is a flowchart illustrating a processing procedure of the anomaly detection device according to the embodiment.

FIG. 9 is a diagram illustrating an example of a computer that executes an anomaly detection program.

### DESCRIPTION OF EMBODIMENTS

Hereinafter, embodiments of an anomaly detection device, an anomaly detection method, and an anomaly detection program according to the present application will be described in detail with reference to the drawings. The embodiments are not intended to limit the scope of the present invention.

### Embodiment

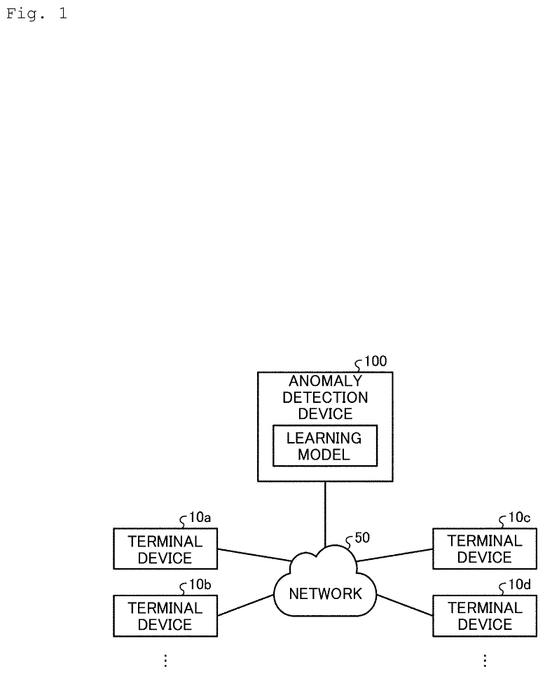

FIG. 1 is a diagram illustrating a configuration example of a network including an anomaly detection device according to the embodiment. For example, the network according to the embodiment includes terminal devices 10a, 10b, 10c, and 10d and an anomaly detection device 100. The terminal devices 10a to 10d and the anomaly detection device 100 are connected to a network 50.

The terminal devices 10a to 10d transmit and receive packets via the network 50. In FIG. 1, the terminal devices 10a to 10d are illustrated, but the system may include other terminal devices. In the following description, the terminal devices 10a to 10d and other terminal devices are collectively described as the “terminal devices 10”.

The anomaly detection device 100 determines whether anomaly communication has occurred by inputting a feature of a packet for a given period transmitted and received on the network 50 to a trained learning model. When anomaly communication has occurred, the anomaly detection device 100 visibly displays a difference between a value for each monitoring item based on a plurality of pieces of learning data used when training the learning model and a value for each monitoring item based on a feature formed of a plurality of packets for a given period (for example, one minute) in which the anomaly communication is detected. Accordingly, it is possible to display information with which types of anomaly communication and differences from normal communication can be ascertained.

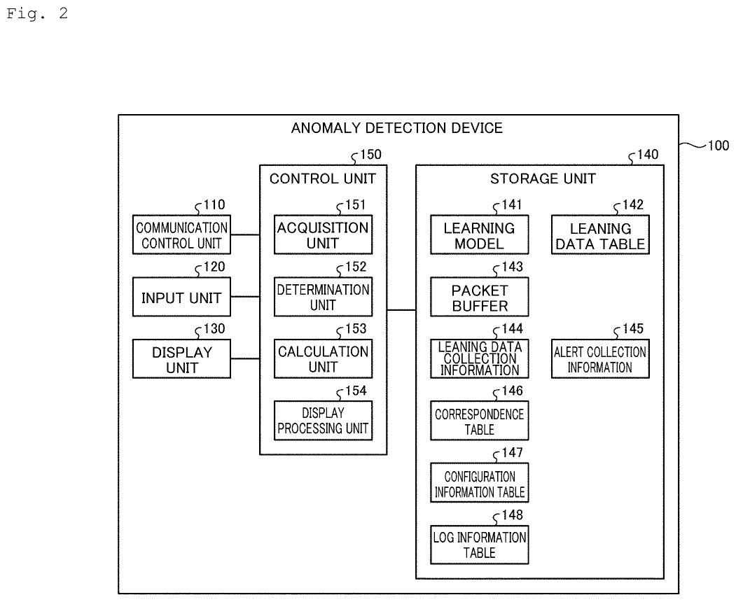

Next, a configuration of the anomaly detection device 100 illustrated in FIG. 1 will be described. FIG. 2 is a functional block diagram illustrating a configuration of an anomaly generation device according to the present example. As illustrated in FIG. 2, the anomaly detection device 100 includes a communication control unit 110, an input unit 120, a display unit 130, a storage unit 140, and a control unit 150.

The communication control unit 110 is implemented by a network interface card (NIC) or the like and controls communication between the terminal device 10 and an external device such as a server connected to the network 50 and the control unit 150.

The input unit 120 is implemented using an input device such as a keyboard or a mouse, and inputs various types of instruction information to the control unit 150 in response to an input operation by an operator.

The display unit 130 is an output device that outputs information acquired from the control unit 150, and is implemented by a display device such as a liquid crystal display, a printing device such as a printer, or the like.

The storage unit 140 stores a learning model 141, a learning data table 142, a packet buffer 143, learning data collection information 144, alert collection information 145, a correspondence table 146, a configuration information table 147, and a log information table 148. The storage unit 140 is implemented using a semiconductor memory element such as a random access memory (RAM) or a flash memory, or a storage device such as a hard disk or an optical disc.

The learning model 141 is a learning model which inputs features of a plurality of packets transmitted and received on the network 50 during a given period and outputs a score of probability of anomaly communication occurring. For example, the learning model 141 is a neural network (NN). The learning model 141 is defined as a trained learning model.

The learning data table 142 stores information regarding learning data. For example, the learning data is information regarding a plurality of packets used during training of the learning model 141, and is information regarding packets transmitted and received on the network 50. In the information regarding each packet, information such as a transmission source MAC address, a transmission destination MAC address, a transmission source IP address, a transmission source port number, a transmission destination IP address, a transmission destination port number, and a protocol is set. In the following description, each item of the transmission source MAC address, the transmission destination MAC address, the transmission source IP address, the transmission source port number, the transmission destination IP address, the transmission destination port number, and a protocol is collectively expressed as a “key item”. In the information regarding each packet, information regarding the acquired date and time may be set.

Here, a features input to the learning model 141 in training are calculated from information regarding packets during a predetermined period (for example, 1 minute) stored in the learning data table 142. For example, the features includes: the number of uplink total packets, the number of uplink total bytes, an uplink average packet size, an uplink average flow rate, the number of downlink total packets, the number of downlink total bytes, a downlink average packet size, a downlink average flow rate, a communication time average, and a count specified from a plurality of packets of the same key item. Learning and determination are performed using the features as basic units. Of the features, the communication time average is a time of continuous communication of one session. The count is the number of repeated accesses.

The packet buffer 143 is a buffer storing information regarding packets transmitted and received on the network 50 when anomaly detection is performed. The information regarding the packets includes information regarding the key items. For example, the packet buffer 143 stores information regarding packets acquired for each given period.

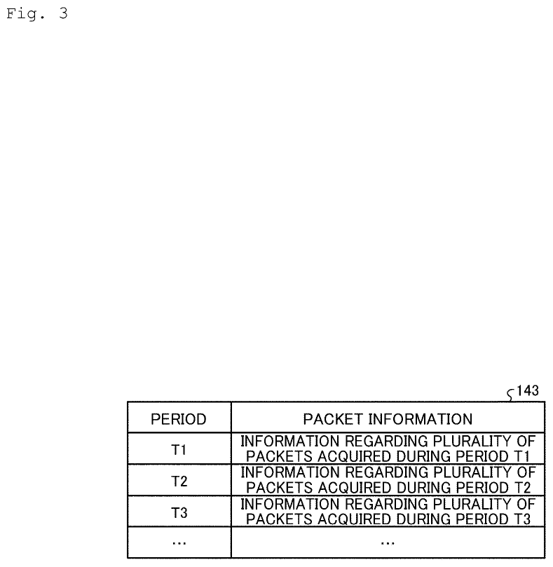

FIG. 3 is a diagram illustrating an example of a data structure of the packet buffer. As illustrated in FIG. 3, the packet buffer stores information regarding a plurality of packets acquired during each of predetermined periods. In the information regarding each packet, information regarding a transmission source MAC address, a transmission destination MAC address, a transmission source IP address, a transmission source port number, a transmission destination IP address, a transmission destination port number, and a protocol is set.

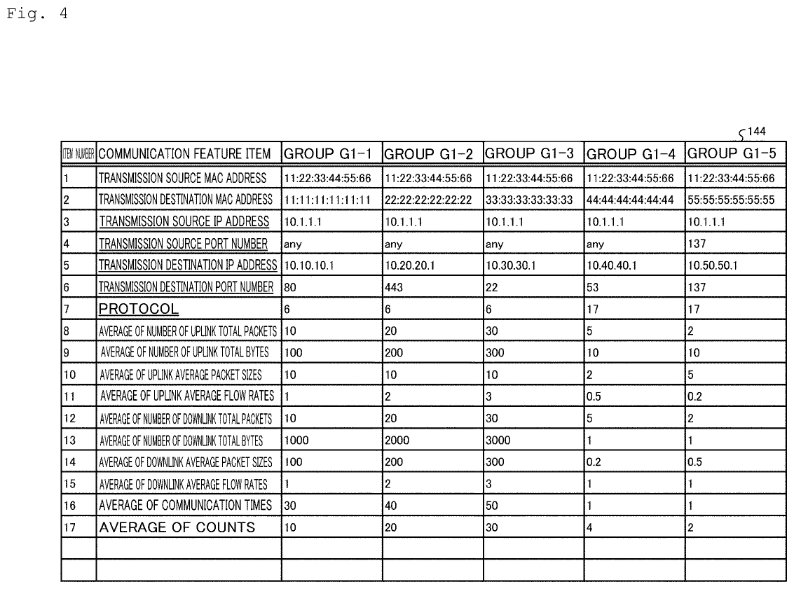

The learning data collection information 144 is generated based on learning data (features formed by information of a plurality of packets during the given period) stored in the learning data table 142. FIG. 4 is a diagram illustrating an example of a data structure of the learning data collection information. As illustrated in FIG. 4, the item number, the communication feature item, and each group are associated with each other in the learning data collection information 144.

The item number is a number for identifying a record of the learning data collection information 144.

In addition to the key items described above, the communication feature items of the learning data collection information 144 include an average of the number of uplink total packets, an average of the number of uplink total bytes, an average of uplink average packet sizes, an average of uplink average flow rates, an average of the number of downlink total packets, an average of the number of downlink total bytes, an average of downlink average packet sizes, an average of downlink average flow rates, an average of communication times, and an average of counts. The communication feature items may further include other items.

In this case, of the plurality of packets stored in the learning data table 142, a plurality of packets with the same key item are classified into the same group. Even when captured periods are different, packets with the same key item are classified into the same group.

For example, a “source MAC address” of a packet classified into group G1-1 is “11:22:33:44:55:66”, a “destination MAC address” is “11:11:11:11:11:11”, a “destination IP address” is “10.1.1.1”, a transmission source port number is “any”, a transmission destination port number is “80”, and a protocol is “6”.

Similarly, for groups G1-2 to G1-5, a plurality of packets with the same key item are classified into the same group.

Although description is omitted in FIG. 4, groups other than groups G1-1 to G1-5 may be further included.

Based on the packets for each period classified into the same group, an average of the number of uplink total packets, an average of the number of uplink total bytes, an average of uplink average packet sizes, an average of uplink average flow rates, an average of the number of downlink total packets, an average of the number of downlink total bytes, an average of downlink average packet sizes, an average of downlink average packet sizes, an average of downlink average flow rates, an average of communication times, and an average of counts are calculated.

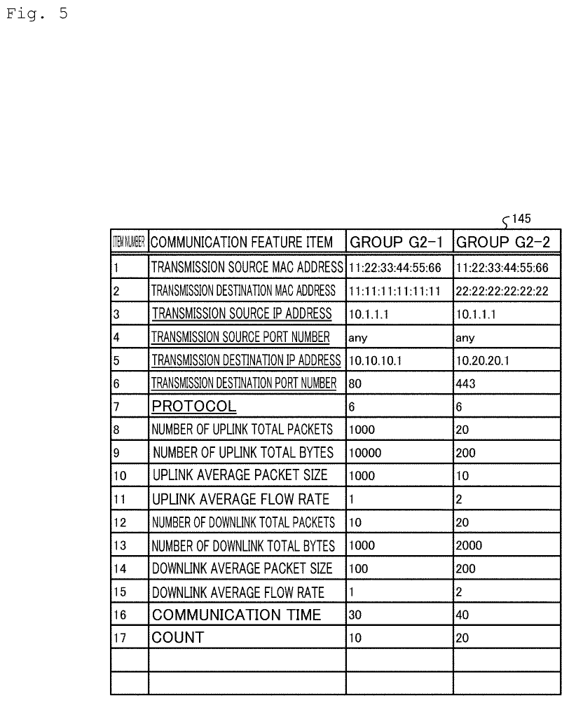

The alert collection information 145 is generated based on information regarding a plurality of packets during a period when anomaly communication is detected. FIG. 5 is a diagram illustrating an example of a data structure of the alert collection information. As illustrated in FIG. 5, in the alert collection information 145, an item number, a communication feature item, and a group are associated with each other.

The communication feature item of the alert collection information 145 includes, in addition to the key items, the number of uplink total packets, the number of uplink total bytes, an uplink average packet size, an uplink average flow rate, the number of downlink total packets, the number of downlink total bytes, a downlink average packet size, a downlink average flow rate, a communication time, and a count.

Here, a plurality of packets with the same key item among a plurality of packets stored in the packet buffer 143 are classified into the same group during a period when anomaly communication is detected.

For example, a “source MAC address” of the packet classified into group G2-1 is “11:22:33:44:55:66”, a “destination MAC address” is “11:11:11:11:11:11”, a “destination IP address” is “10.1.1.1”, a transmission source port number is “any”, a transmission destination port number is “80”, and a protocol is “6”.

Similarly, for group G2-1, packets with the same key item are classified into the same group. Although description is omitted in FIG. 4, groups other than groups G1-1 to G1-2 may be further included.

Based on a plurality of packets classified into the same group and packets during a period (latest period) in which anomaly communication is detected, an average of the number of uplink total packets, an average of the number of uplink total bytes, an average of uplink average packet sizes, an average of uplink average packet rates, an average of the number of downlink total packets, an average of the number of downlink total bytes, an average of downlink average packet sizes, an average of downlink average flow rates, an average of communication times, and an average of counts are calculated.

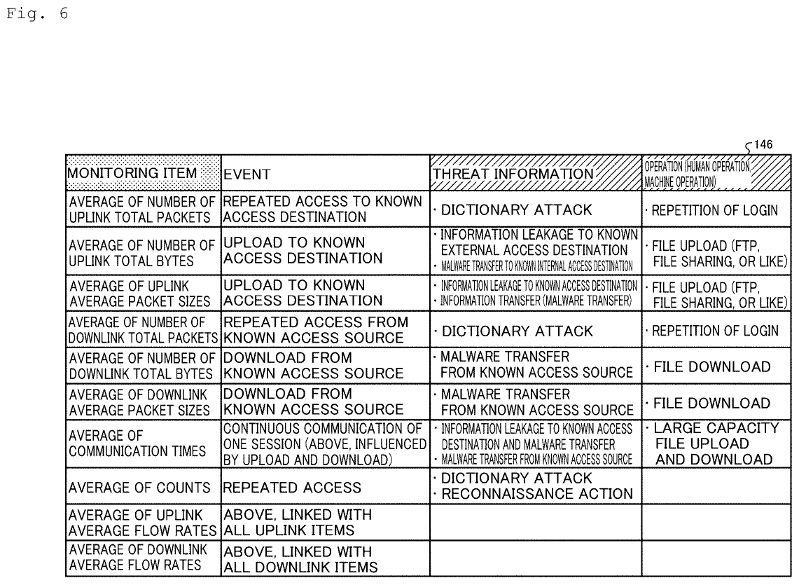

The correspondence table 146 associates items to be monitored with information regarding an assumed threat. FIG. 6 is a diagram illustrating an example of a data structure of a correspondence table. As illustrated in FIG. 6, in the correspondence table 146, monitoring items, events, threat information, and operations are associated with each other.

The monitoring items are items to be monitored. The events corresponds to the monitoring items. The threat information is information regarding a threat assumed for the monitoring item. The operation is an operation of generating an event (a human operation or a machine operation).

In the example illustrated in FIG. 6, monitoring items include the number of uplink total packets (average thereof), the number of uplink total bytes (average thereof), the number of uplink average packet sizes (average thereof), the number of downlink total packets (average thereof), the number of downlink total bytes (average thereof), downlink average packet sizes (average thereof), communication times (average thereof), counts (average thereof), uplink average flow rates (average thereof), and downlink average flow rates (average thereof).

For example, an event corresponding to the monitoring item “average of the number of uplink total packets” is “repeated access to a known access destination”, the threat information is “dictionary attack”, and the operation is “repeated login”. As illustrated in FIG. 6, the events, the threat information, and the operations are also set for other monitoring items.

The configuration information table 147 stores configuration information of each terminal device 10. The configuration information includes information regarding a list of software installed in the terminal device 10 and information regarding processing that is being executed by the terminal device 10. The configuration information may include information regarding hardware such as a central processing unit (CPU) set in the terminal device 10. For example, the configuration information table 147 stores information for identifying the terminal device 10 (IP address or the like of the terminal device 10) and the configuration information in association.

An execution log of each terminal device 10 is stored in the log information table 148. For example, the log information table 148 stores information for identifying the terminal device 10 and log information in association.

The control unit 150 controls the entire anomaly detection device 100. The control unit 150 includes an acquisition unit 151, a determination unit 152, a calculation unit 153, and a display control unit 154. The control unit 120 is a hardware processor such as a CPU or a micro processing unit (MPU).

The acquisition unit 151 acquires (captures) a packet transmitted and received on a network 50. The acquisition unit 151 stores the information regarding the acquired packet in the packet buffer 143. For example, the acquisition unit 151 acquires information regarding a plurality of packets during each given period, and stores the information in association with information regarding a plurality of packets acquired during a period related to the period in the packet buffer 143.

Further, the acquisition unit 151 periodically accesses the terminal device 10 connected to the network 50, and acquires the configuration information and the log information from the terminal device 10. The acquisition unit 151 associates information for identifying the terminal device 10 with the configuration information and stores the information in the configuration information table 147. The acquisition unit 151 associates the information for identifying the terminal device 10 with the log information and registers the information in the log information table 148.

The determination unit 152 determines whether the anomaly communication has occurred for each given period. For example, a case in which the determination unit 152 determines whether the anomaly communication has occurred during a certain period T1 will be described.

The determination unit 152 acquires the information regarding a plurality of packets acquired during the period T1 from the packet buffer 143 and classifies the plurality of packets into a plurality of groups so that the packets with the same value of the key item are classified into the same group.

The determination unit 152 calculates features based on the information regarding the plurality of packets classified into the same group. For example, the features calculated by the determination unit 152 includes: the number of uplink total packets, the number of uplink total bytes, an uplink average packet size, an uplink average flow rate, the number of downlink total packets, the number of downlink total bytes, a downlink average packet size, a downlink average flow rate, a communication time, and a count. The determination unit 152 may calculate the features using any known technique.

The determination unit 152 inputs the calculated features to the trained learning model 141 and determines that anomaly communication has occurred during the period T1 when a score output from the learning model 141 is equal to or more than a threshold. When it is determined that the anomaly communication has occurred, the determination unit 152 outputs information indicating that the anomaly communication is detected during the period T1 to the calculation unit 153.

The determination unit 152 repeatedly executes the processing even on the information regarding the packets acquired during another period.

The calculation unit 153 generates the learning data collection information 144 based on the learning data table 142. The calculation unit 153 generates the alert collection information 145 based on information regarding a plurality of packets acquired during a period in which anomaly communication has occurred.

First, an example of processing for generating the learning data collection information 144 based on the learning data table 142 by the calculation unit 153 will be described. The calculation unit 153 acquires the information regarding the plurality of packets stored in the learning data table 142.

The calculation unit 153 classifies the information regarding the plurality of acquired packets into a plurality of groups so that packets with the same value of the key item are classified into the same group. Based on a plurality of pieces of packet information that belong to other periods and are information regarding the plurality of packets classified into the same group, the calculation unit 153 calculates the number of uplink total packets, the number of uplink total bytes, an uplink average packet size, an uplink average flow rate, the number of downlink total packets, the number of downlink total bytes, a downlink average packet size, a downlink average flow rate, a communication time, and a count. Then, the calculation unit 153 calculates an average of the number of uplink total packets, an average of the number of uplink total bytes, an average of uplink average packet sizes, an average of uplink average flow rates, an average of the number of downlink total packets, an average of the number of downlink total bytes, an average of downlink average packet sizes, an average of downlink average packet rate, an average of communication times, and an average of the counts by averaging the information calculated from each period.

The calculation unit 153 generates the learning data collection information 144 described in FIG. 4 by repeatedly executing the above processing for each group (groups G1-1 to G1-5). The calculation unit 153 may generate the learning data collection information 144 at a timing at which the determination unit 152 detects anomaly communication during a certain period or may generate the learning data collection information 144 in advance.

Next, the processing for generating the alert collection information 145 based on the packet buffer 143 by the calculation unit 153 will be described. Here, processing in which anomaly communication is detected during the certain period T1 by the determination unit 152 will be described. The calculation unit 153 acquires information regarding the plurality of packets during the period T1 stored in the packet buffer 143.

The calculation unit 153 classifies the information regarding the plurality of acquired packets into a plurality of groups so that packets with the same value of the key item are classified into the same group. Based on information on the plurality of packets classified into the same group, the calculation unit 153 calculates the number of uplink total packets, the number of uplink total bytes, an uplink average packet size, an uplink average flow rate, the number of downlink total packets, the number of downlink total bytes, a downlink average packet size, a downlink average flow rate, a communication time, and a count.

Based on the information regarding the plurality of packets classified into each group, the calculation unit 153 generates the alert collection information 145 described with reference to FIG. 5 by repeatedly executing the above processing. The calculation unit 153 repeatedly executes the processing whenever the determination unit 152 detects the anomaly communication.

Based on the learning data collection information 144 and the alert collection information 145, the display control unit 154 generates screen information that allows a user to visually recognize a difference between a value for each monitoring item based on a plurality of pieces of learning data used when training the learning model and a value for each monitoring item based on the plurality of packets during the given period in which anomaly communication is detected, and causes the display unit 130 to display the screen information.

For example, the monitoring items are assumed to be the number of uplink total packets, the number of uplink total bytes, the uplink average packet size, the uplink average flow rate, the number of downlink total packets, the number of downlink total bytes, the downlink average packet size, the downlink average flow rate, the communication time, and the count.

The display control unit 154 acquires information regarding the groups in which key items match from the learning data collection information 144 and the alert collection information 145, and calculates a difference (absolute value of the difference) between values for each monitoring item.

The display control unit 154 sets a unique threshold for each monitoring item and specifies values of corresponding monitoring items of the alert collection information 145 as values of the monitoring items with deviation when the difference between the values of the monitoring items is equal to or greater than the threshold. The display control unit 154 specifies the value of the corresponding monitoring item of the alert collection information 145 as a value of a similar monitoring item when the difference between the values of the monitoring items is less than the threshold.

For example, thresholds Th1, Th2, Th3, Th4, Th5, Th6, Th7, Th8, Th9, Th10 are respectively set in the number of uplink total packets (average thereof), the number of uplink total bytes (average thereof), uplink average packet sizes (average thereof), the number of downlink total packets (average thereof), the number of downlink total bytes (average thereof), downlink average packet sizes (average thereof), communication times (average thereof), counts (average thereof), uplink average flow rates (average thereof), and downlink average flow rates (average thereof) included in the monitoring items.

The processing of the display control unit 154 will be described using the information regarding group G1-1 of the learning data collection information 144 and the information of group G2-1 of the alert collection information 145. The values of the key items of group G1-1 match the values of the key items of group G2-1.

The display control unit 154 calculates a difference “990” between a value “10” of the monitoring item “the average of the number of uplink total packets” of group G1-1 and a value “1000” of the monitoring item “number of uplink total packets” of group 2-1. When the difference “990” is equal to or more than the threshold Th1, the display control unit 154 specifies the value “1000” of the corresponding monitoring item “the number of uplink total packets” of the alert collection information 145 as a value of the monitoring item with the deviation.

The display control unit 154 calculates a difference “0” between a value “10” of the monitoring item “the average of the number of downlink total packets” of group G1-1 and a value “10” of the monitoring item “the number of downlink total packets” of group 2-1. When the difference “0” is less than the threshold Th4, the display control unit 154 specifies a value “10” of the corresponding monitoring item “the number of downlink total packets” of the alert collection information 145 as a value of a similar monitoring item.

The display control unit 154 classifies the value of the monitoring item as the value of the monitoring item with deviation or the value of the monitoring item into a value of a similar monitoring item by repeatedly executing the processing on the other monitoring items.

When the value of the monitoring item is classified into the value of the monitoring item with deviation, the display control unit 154 acquires the configuration information of the corresponding terminal device from the configuration information table 147 and acquires the log information of the corresponding terminal device from the log information table 148. For example, in the above example, since the value “1000” of the monitoring item “the number of uplink total packets” of group 2-1 is classified into the value of the monitoring item with deviation, the display control unit 154 acquires the configuration information and the log information of the terminal device corresponding to the value of the key item of group G2-1 (for example, a transmission source IP address: 10.1.1.1).

The display control unit 154 compares the monitoring item with deviation with the correspondence table 146 and specifies threat information corresponding to the monitoring item with deviation. For example, the display control unit 154 specifies the threat information “dictionary attack” when the monitoring item with deviation becomes “the number of uplink total packets (average thereof)”.

The display control unit 154 generates screen information in which a period in which the anomaly communication is detected, a value of the monitoring item with deviation, threat information, a value of a similar monitoring item, the learning data collection information 144, the configuration information, the log information, and the like are set.

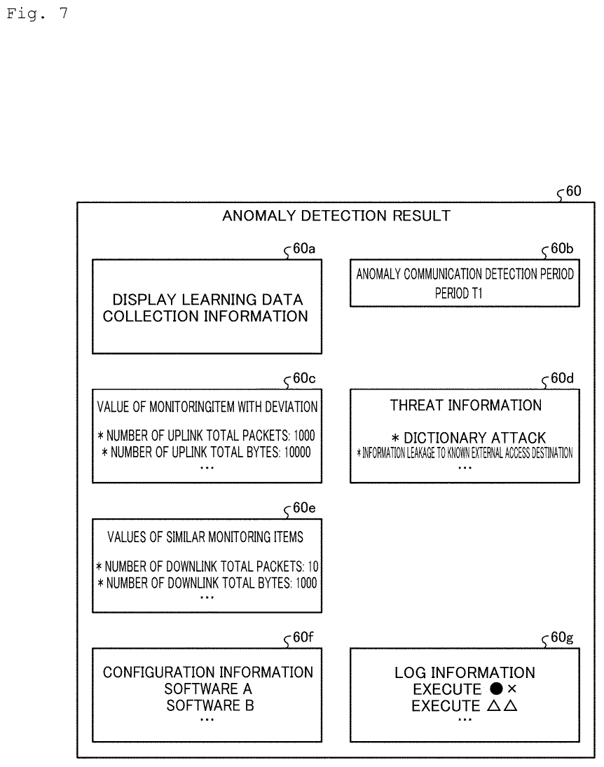

FIG. 7 is a diagram illustrating an example of the screen information generated by the display control unit. For example, display areas 60a, 60b, 60c, 60d, 60e, 60f, and 60g are set in the screen information 60. In the display area 60a, the learning data collection information 144 described in FIG. 4 is set to be visible. In the display area 60b, a period in which anomaly communication is detected is set to be visible.

In the display area 60c, a value of a monitoring item with deviation is set to be visible. In the display area 60d, threat information is set to be visible. In the display area 60e, a value of a similar monitoring item is set to be visible. In the display area 60f, the configuration information acquired by the display control unit 154 is set to be visible. In the display area 60g, the log information acquired by the display control unit 154 is set to be visible. A display mode of the screen information 60 illustrated in FIG. 7 is exemplary, and other information such as the alert collection information 145 may be displayed together or highlighted for display.

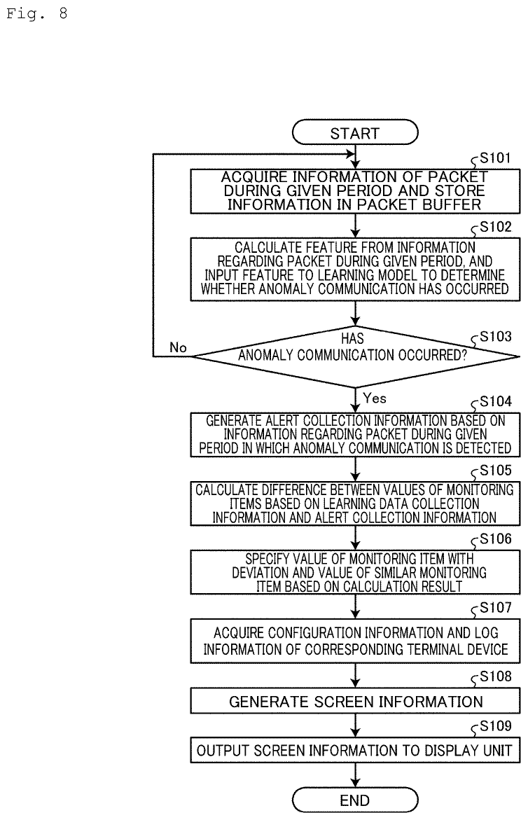

Next, an example of a processing procedure of the anomaly detection device according to the embodiment will be described. FIG. 8 is a flowchart illustrating a processing procedure of the anomaly detection device according to the embodiment. As illustrated in FIG. 8, the acquisition unit 151 of the anomaly detection device 100 acquires information regarding packets during the given period and stores the information in the packet buffer 143 (step S101).

The determination unit 152 of the anomaly detection device 100 determines whether anomaly communication has occurred by calculating features from the information regarding the packets during the given period stored in the packet buffer 143, and inputting the features to the learning model 141 (step S102).

When the anomaly communication has not occurred (No in step S103), the determination unit 152 moves to step S101. Conversely, when the anomaly communication has occurred (Yes in step S103), the determination unit 152 moves to step S104.

The calculation unit 153 of the anomaly detection device 100 generates the alert collection information 144 based on information regarding the packets during the given period in which the anomaly communication is detected (step S104). The display control unit 154 of the anomaly detection device 100 calculates a difference of each monitoring item based on the learning data collection information 144 and the alert collection information 145 (step S105).

The display processing unit 154 specifies a value of a monitoring item with deviation and a value of a similar monitoring item based on the calculation result (step S106). The display control unit 154 acquires the configuration information and the log information of the corresponding terminal device 10 (step S107).

The display processing unit 154 generates the screen information (for example, the screen information 60 illustrated in FIG. 7) (step S108). The display processing unit 154 outputs the screen information to the display unit Next, the effects of the anomaly detection device 100 according to the embodiment will be described. The anomaly detection device 100 determines whether the anomaly communication has occurred by inputting the features of the packets during the given period transmitted and received on the network 50 to the trained learning model 141. When the anomaly communication has occurred, the anomaly detection device 100 visibly displays a difference between a value for each monitoring item based on a plurality of pieces of learning data used at the time of training of the learning model 141 and a value for each monitoring item based on the plurality of packets during the given period in which the anomaly communication is detected. Thus, information with which a type of anomaly communication and a type of difference from normal communication can be ascertained can be displayed.

The anomaly detection device 100 classifies the plurality of packets into the plurality of groups so that the packets with the same key item are classified into the same group based on the learning data table 142, and generates the learning data collection information 144. Accordingly, it is possible to calculate features for each group related to the plurality of packets corresponding to learning data used at the time of training of the learning model 141.

The anomaly detection device 100 classifies the plurality of packets into the plurality of groups so that the packets with the same key item are classified into the same group with regard to a plurality of pieces of packet information during the given period in which the anomaly communication is detected based on the packet buffer 143, and generates the alert collection information 145. Accordingly, the features can be calculated for each group related to the plurality of packets captured during the given period in which the anomaly communication is detected.

The anomaly detection device 100 can visibly display the difference between the value for each monitoring item of the learning data collection information 144 and the value for each monitoring item of the alert collection information 145.

The anomaly detection device 100 displays the threat information corresponding to the monitoring items based on the correspondence table 146. Accordingly, it is possible to notify of the threat information related to the anomaly communication.

The anomaly detection device 100 displays the configuration information and the log information of the terminal device 10 related to the packet communication in which the anomaly communication has occurred. Accordingly, information closely related to the anomaly communication can be further presented.

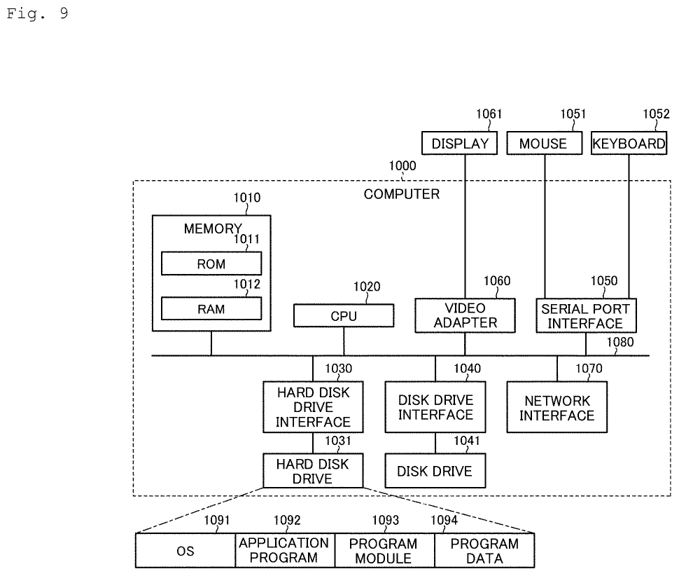

Next, an example of a computer that executes the anomaly detection program will be described. FIG. 9 is a diagram illustrating an example of a computer that executes an anomaly detection program. A computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031.

The disk drive interface 1040 is connected to the disk drive 1041. A removable storage medium such as a magnetic disk or an optical disc is inserted into, for example, the disk drive 1041. A mouse 1051 and a keyboard 1052 are connected to, for example, the serial port interface 1050. A display 1061 is connected to, for example, the video adapter 1060.

Here, the hard disk drive 1031 stores, for example, an OS 1091, an application programs 1092, a program module 1093 and program data 1094. Each piece of information described in the above embodiment is stored in, for example, the hard disk drive 1031 or the memory 1010.

The anomaly detection program is stored in, for example, the hard disk drive 1031 as the program module 1093 in which commands executed by the computer 1000 are described.

Specifically, the program module 1093 in which each processing executed by the acquisition unit 151, the determination unit 152, the calculation unit 153, and the display control unit 154 described in the above embodiment is described is stored in the hard disk drive 1031.

Data used for information processing by the anomaly detection program is stored as the program data 1094, for example, in the hard disk drive 1031. The CPU 1020 reads the program module 1093 and the program data 1094 stored in the hard disk drive 1031 to the RAM 1012 and executes each of the above-described procedures, as necessary.

The program module 1093 and the program data 1094 related to the anomaly detection program are not limited to being stored in the hard disk drive 1031 and may be stored in, for example, a removable storage medium and may be read by the CPU 1020 via the disk drive 1041 or the like. Alternatively, the program module 1093 and the program data 1094 related to the anomaly detection program may be stored in another computer connected via a network such as a LAN or a wide area network (WAN), and read out by the CPU 1020 via the network interface 1070.

Although the embodiments to which the invention made by the present inventor is applied have been described above, the present invention is not limited to the description and drawings that are parts of the disclosure of the present invention according to the present embodiments. That is, all other embodiments, examples, operational techniques, and the like made by those skilled in the art based on the embodiment are included in the scope of the present invention.

### REFERENCE SIGNS LIST

100 Anomaly detection device
110 Communication control unit
120 Input unit
130 Display unit
140 Storage unit
141 Learning model
142 Learning data table
143 Packet buffer
144 Learning data collection information
145 Alert collection information
146 Correspondence table
147 Configuration information table
148 Log information
151 Acquisition unit
152 Determination unit
153 Calculation unit
154 Display control unit

1. An anomaly detection device comprising:
processing circuitry configured to:
determine whether anomaly communication has occurred by inputting a feature of a packet during a given period transmitted and received on a network to a learning model trained in advance using a plurality of pieces of learning data;
calculate a value for each monitoring item of the packet during the given period when the anomaly communication has occurred; and
visibly display a difference between a value for each monitoring item of the plurality of pieces of learning data and a value for each feature item of the packet during the given period.

2. The anomaly detection device according to claim 1, wherein the processing circuitry is further configured to classify the plurality of pieces of learning data into a plurality of first groups based on a predetermined item, calculate a value for each monitoring item for each classified first group, classify packets during the given period into a plurality of second groups based on the predetermined item, and calculate a value for each monitoring item for each of the classified second groups.

3. The anomaly detection device according to claim 2, wherein the processing circuitry is further configured to visibly display a difference between a value of the monitoring item of the first group and a value of the monitoring item of the second group in which a predetermined item matches.

4. The anomaly detection device according to claim 1, wherein the processing circuitry is further configured to display information regarding a threat assumed for the monitoring item.

5. The anomaly detection device according to claim 1, wherein the processing circuitry is further configured to acquire configuration information and log information of a terminal device from a plurality of terminal devices that transmit and receive the packet and display the configuration information and the log information of the terminal device corresponding to the packet during the given period.

6. An anomaly detection method comprising:
determining whether anomaly communication has occurred by inputting a feature of a packet transmitted and received on a network during a given period to a learning model trained in advance using a plurality of pieces of learning data;
calculating a value for each monitoring item of the packet during the given period when the anomaly communication has occurred; and
visibly displaying a difference between a value for each monitoring item of the plurality of pieces of learning data and a value for each feature item of the packet during the given period.

7. A non-transitory computer-readable recording medium storing therein an anomaly detection program that causes a computer to execute a process comprising:
determining whether anomaly communication has occurred by inputting a feature of a packet transmitted and received on a network during a given period to a learning model trained in advance using a plurality of pieces of learning data;
calculating a value for each monitoring item of the packet in the given period when the anomaly communication has occurred; and
visibly displaying a difference between a value of each monitoring item of the plurality of pieces of learning data and a value of each feature item of the packet in the given period.
